(19) United States
(12) Patent Application Publication
(10) Pub. No.: US 2013/0343265 A1
(43) Pub. Date: Dec. 26, 2013

(54) METHODS AND APPARATUS FOR ALIGNING VOICE CODER AND SCHEDULING TIMING

(71) Applicants: Navid Ehsan, San Diego, CA (US); Thomas Klingenbrunn, San Diego, CA (US); Min Wang, San Diego, CA (US); Amir Aminzadeh Gohari, San Diego, CA (US)

(72) Inventors: Navid Ehsan, San Diego, CA (US); Thomas Klingenbrunn, San Diego, CA (US); Min Wang, San Diego, CA (US); Amir Aminzadeh Gohari, San Diego, CA (US)

(73) Assignee: QUALCOMM INCORPORATED, San Diego, CA (US)

(21) Appl. No.: 13/531,374

(22) Filed: Jun. 22, 2012

(51) Int. Cl. H04L 12/66; H04W 4/00

(52) U.S. Cl. 370/328; 370/352

(57) ABSTRACT

The described aspects include methods and apparatus for aligning a voice over data vocoder timing at a user equipment (UE). A scheduling interval timing is determined at the UE, and a timing of a vocoder of the UE can be aligned based on the scheduling interval timing. The UE transmits one or more packets generated by the vocoder according to the timing in at least one transmission period related to the scheduling interval timing. Thus, time delay between packet generation and transmission can be minimized.

### BACKGROUND

1. Field

The following description relates generally to wireless network communications, and more particularly to voice over data communications.

2. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP) (e.g., 3GPP LTE (Long Term Evolution)/LTE-Advanced), ultra mobile broadband (UMB), evolution data optimized (EV-DO), etc.

Generally, wireless multiple-access communication systems may simultaneously support communication for multiple mobile user equipment (UE). Each UE may communicate with one or more evolved Node B (eNB) via transmissions on forward and reverse links. The forward link (or downlink) refers to the communication link from eNB to UE, and the reverse link (or uplink) refers to the communication link from UE to eNB. Further, communications between UE and eNB may be established via single-input single-output (SISO) systems, multiple-input single-output (MISO) systems, multiple-input multiple-output (MIMO) systems, and so forth.

In addition, UEs can implement voice-over-internet protocol (VoIP) to provide voice communications over a data connection, where UEs can convert analog voice signals to digital packet data and communicate the packets in a wireless network. Minimizing delay associated with communicating such packets can be desirable to ensure call quality and user experience. For example, an encoder for voice communications (referred to as a vocoder) is used to generate data packets from analog voice signals according to a time interval. Where a corresponding UE receives scheduling grants from an eNB at the beginning of the time interval before the data packets are generated, the UE does not send the data packets until the next time interval, which can introduce delay in the voice communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, the present disclosure describes various aspects in connection with aligning timing of a vocoder relating to voice over data communications based on timing of scheduling in a wireless communication system. In this regard, the vocoder can complete a process for generating data packets for voice communication near the time of receiving scheduling grants or opportunities to request such grants for the data packets. This allows the data packets to be transmitted soon after generation, thus minimizing delay associated with waiting for a scheduling grant or opportunities to request such grants after generating the data packets. In an example, the vocoder can obtain scheduling interval timing from a scheduler at a related user equipment (UE) and can set the vocoder timing before the scheduling interval timing (e.g., according to known delay for packet generation).

In one example, a method for aligning a voice-over-internet protocol (VoIP) vocoder timing at a UE is provided. The method includes determining a scheduling interval timing at a UE and aligning a timing of a vocoder of the UE based on the scheduling interval timing. The method further includes transmitting one or more packets generated by the vocoder according to the timing in at least one transmission period related to the scheduling interval timing.

In another example, an apparatus for aligning a VoIP vocoder timing at a UE is provided including means for determining a scheduling interval timing at a UE and means for aligning a timing of a vocoder of the UE based on the scheduling interval timing. The apparatus further includes means for transmitting one or more packets generated by the vocoder according to the timing in at least one transmission period related to the scheduling interval timing.

Moreover, in an example, a computer program product for aligning a VoIP vocoder timing at a UE is provided including a non-transitory computer-readable medium having code for causing at least one computer to determine a scheduling interval timing at a UE and code for causing the at least one computer to align a timing of a vocoder of the UE based on the scheduling interval timing. The computer-readable medium further includes code for causing the at least one computer to transmit one or more packets generated by the vocoder according to the timing in at least one transmission period related to the scheduling interval timing.

Further, in an example, an apparatus for aligning a VoIP vocoder timing at a UE is provided including a processor, and a memory in electronic communication with the processor. Instructions are stored on the memory and are executable by the processor to determine a scheduling interval timing at a UE, align a timing of a vocoder of the UE based on the scheduling interval timing, and transmit one or more packets generated by the vocoder according to the timing in at least one transmission period related to the scheduling interval timing.

Still, in another example, an apparatus for aligning a VoIP vocoder timing at a UE is providing including a scheduling timing determining component for determining a scheduling interval timing at a UE, a timing aligning component for aligning a timing of a vocoder of the UE based on the scheduling interval timing, and a transmitting component for transmitting one or more packets generated by the vocoder according to the timing in at least one transmission period related to the scheduling interval timing.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 illustrates an example system for aligning timing of a vocoder of a user equipment (UE).

FIG. 2 illustrates example timelines for scheduling resources in a wireless network.

FIG. 3 illustrates an example process for encoding and transmitting voice over data communications in a wireless network.

FIG. 4 illustrates an example methodology for aligning timing of a vocoder based on a scheduling timing interval.

FIG. 5 illustrates an example mobile device in accordance with aspects described herein.

FIG. 6 is a diagram illustrating an example of a network architecture.

FIG. 7 is a diagram illustrating an example of an access network.

FIG. 8 is a diagram illustrating an example of a downlink (DL) frame structure in long term evolution (LTE).

FIG. 9 is a diagram illustrating an example of an uplink (UL) frame structure in LTE.

FIG. 10 is a diagram illustrating an example of a radio protocol architecture for the user and control planes.

FIG. 11 is a diagram illustrating an example of an eNB and UE in an access network.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Described herein are various aspects related to aligning timing of an encoder for generating data packets from voice communications (referred to herein as a vocoder) based on a scheduling interval timing in a wireless network. In one example, a user equipment (UE) employing the vocoder can obtain the scheduling interval timing from a scheduler that receives resource grants in the wireless network. Based on the scheduling interval timing, the UE can align timing of the vocoder to result in packet generation for voice communications within a threshold time prior to receiving resource grants at the scheduler to minimize delay between completion of generating the packets and communication of the packets over scheduled resources. In one example, the UE can also account for known delay at the vocoder related to generating the data packets in aligning the timing. In any case, aligning the vocoder timing based on scheduling interval timing allows for completing generation of data packets near the timing for receiving a scheduling grant to transmit the packets, which can minimize associated delay in voice communications.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

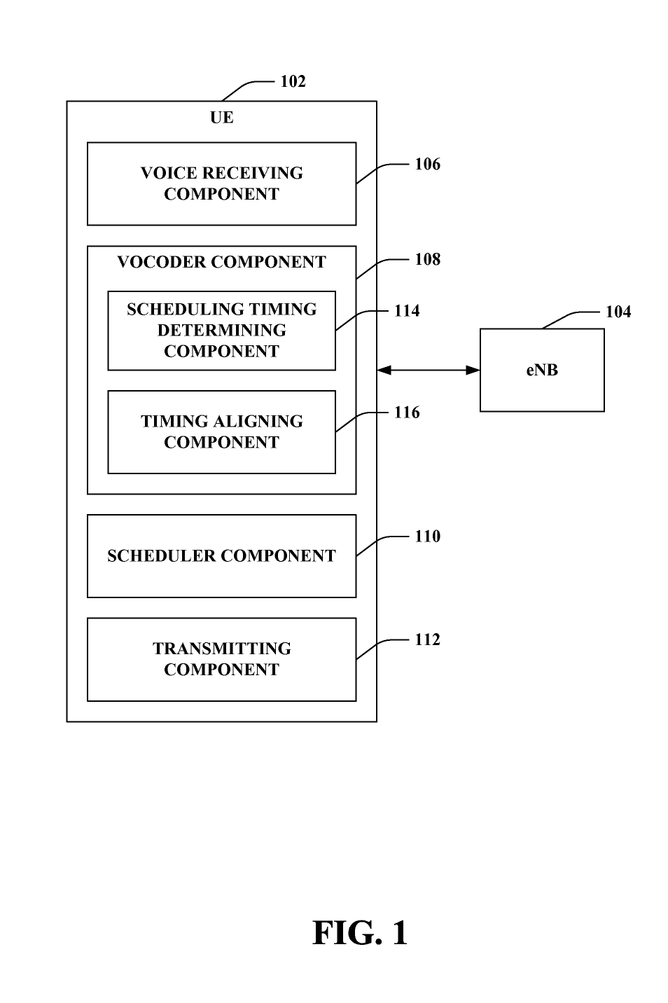

FIG. 1 illustrates an example wireless communication system 100 that facilitates aligning vocoder timing at a UE. System 100 includes a UE 102 that communicates with an eNB 104 to access to a wireless network. UE 102 can be a mobile terminal, a stationary terminal, a tethered device (such as a modem), a portion thereof, and/or the like. Moreover, eNB 104 can be a macro node, femto node, pico node, micro node, or similar eNB, a relay node, a mobile base station, a UE (e.g., communicating in peer-to-peer or ad-hoc mode with UE 102), a portion thereof, and/or the like. In addition, eNB 104 can facilitate UE 102 communication with a core network (not shown) to receive wireless network services, such as circuit-switched (CS) voice services, packet-switched (PS) voice services including voice-over-internet protocol (VoIP), other data services, and/or the like.

UE 102 can include a voice receiving component 106 for obtaining audio input (e.g., analog voice signals), a vocoder component 108 for generating digital voice data packets based on the input, a scheduler component 110 for scheduling data communication with an eNB based on resources scheduled with the eNB, and a transmitting component 112 for communicating data packets to the eNB over scheduled resources. In addition, vocoder component 108 can include a scheduling timing determining component 114 for obtaining a scheduling interval timing related to scheduling information received from the eNB, and a timing aligning component 116 for adjusting packet generation timing at the vocoder component 108 based on the obtained scheduling interval timing.

According to an example, voice receiving component 106 can obtain analog audio signals for encoding. The analog signals, for example, can include analog voice signals received over a microphone or other input device. Vocoder component 108 can generate digital data packets from the voice signals for communicating in a wireless network. In one example, vocoder component 108 can generate the packets according to a sampling interval, such as every 20 milliseconds (ms). Thus, for example, vocoder component 108 can generate data packets every 20 ms for voice signals received over the 20 ms sampling interval. Vocoder component 108 can provide the packets to lower layer for scheduling/transmission thereof.

Scheduler component 110 can receive resource assignments from eNB 104 for communicating in the wireless network, and transmitting component 112 can transmit data, including the digital data packets generated by vocoder component 108, during the scheduled resource assignments. Such assignments can be received and/or requested according to certain time intervals. Thus, where timing of the resource assignments and the sampling interval of packet generation at the vocoder component 108 are on similar scale, timing of the sampling and/or subsequent packet generation at the vocoder component 108 can be adjusted to attempt to complete packet generation within a threshold time before the assigned resources. This minimizes delay in transmitting the packets. Scheduler component 110, for example, can include a MAC layer scheduler, and transmitting component 112 can include a physical layer transmit processor and/or related antenna(s). Moreover, for example, vocoder component 108 can generate the data packets as a VoIP, voice-over-LTE (VoLTE) or similar packets for transmitting over the wireless network.

In one example, eNB 104 can utilize dynamic scheduling to schedule resources to UE 102. In this case, scheduler component 110 can initially send a scheduling request (SR) to the eNB 104 to notify of data to send at UE 102. eNB can then allocate resources for UE 102, and communicate an indication of resources to the UE 102 in an uplink grant. Scheduler component 110 can then schedule data for transmitting over the resources indicated in the uplink grant (e.g., time and/or frequency) by transmitting component 112. Timing during which scheduler component 110 can transmit SR can be limited and configured by eNB 104 to the scheduler component 110 as a SR configuration, which can include an SR periodicity and/or an SR offset from a current subframe. Thus, scheduler component 110 is aware of scheduling interval timing for requesting an uplink grant by sending SRs to the eNB 104. In this example, scheduling timing determining component 114 can obtain the SR configuration from the scheduler component 110, or otherwise obtain the absolute timing at which the scheduler 110 transmits SRs. In one example, the SR periodicity in the configuration can be on the scale of vocoder packet generation timing (e.g., a multiple of n ms, where the vocoder packet generation occurs every n ms). Timing aligning component 116 can align timing of sampling and/or packet generation at vocoder component 108 so that packet generation is complete, and the packet is provided to the lower layers for scheduling/transmission, shortly before the SR according to the scheduling interval timing. This can ensure the data packets are ready for transmitting when the SR occurs, and thus scheduler component 110 can request an SR for transmitting the data packets from vocoder component 108 soon after packet generation. Transmitting component 112 can transmit the data packets in a corresponding transmission period scheduled based on the SR.

In addition, for example, eNB 104 can configure a discontinuous receive (DRX) active time at UE 102 to allow the UE 102 to receive/transmit in certain scheduled time periods and power down its transceiver components during periods outside of the scheduled time periods. In this example, timing aligning component 116 can similarly align the timing for packet generation at vocoder component 108 to produce data packets for transmitting before the DRX period begins based on obtaining the DRX active time from the scheduler component 110.

In another example, eNB 104 can utilize semi-persistent scheduling (SPS) in scheduling resources to UE 102 for communicating therewith. In this example, eNB 104 grants UE 102 specific allocations with a preconfigured periodicity for transmitting on the uplink. In this example, eNB 104 can indicate the scheduling interval timing to UE 102 to allow UE 102 to use the SPS grants, or eNB 104 at least indicates the use of SPS to UE 102, where the UE 102 is preconfigured with the periodicity and/or offset. In this example, scheduler component 110 determines scheduling interval timing based on the periodicity, offset, and/or other timing parameters for receiving an initial SPS grant, for example.

In either case, for example, scheduling timing determining component 114 can obtain the scheduling interval timing as the SPS scheduling periodicity and/or offset, or otherwise the absolute timing for expected SPS grants, from scheduler component 110. In one example, the SPS grant periodicity can be on the scale of vocoder packet generation (e.g., a multiple of n ms, where the vocoder packet generation occurs every n ms). Timing aligning component 116 can align timing of sampling and/or packet generation at vocoder component 108 based on the scheduling interval timing in an attempt to complete packet generation shortly before the SPS grant. This can ensure the data packets are ready for transmitting when the SPS grant is received, and thus scheduler component 110 can schedule the data packets for transmitting by transmitting component 112 over the transmission period of the SPS grant.

In addition, timing aligning component 116 can align vocoder component 108 timing for packet generation based on adding expected delay for packet generation to the scheduling interval timing (e.g., a timing of the next SR opportunity or SPS grant), as received from scheduler component 110. Thus, timing of vocoder component 108 packet generation can be adjusted to begin at the computed time and complete after the expected delay in time for the SR opportunity or SPS grant. In this example, timing aligning component 116 can determine the expected delay parameter as hardcoded at UE 102, or otherwise received by timing aligning component 116 in a configuration (e.g., network or UE 102 based configuration). In another example, timing aligning component 116 can determine the expected delay parameter based on historical delay parameters that provide favorable voice data packet transmission delays, and/or the like. In this example, timing aligning component 116 can determine whether previous expected delay parameters resulted in acceptable delay between generating voice data packets and transmitting the packets, such as by measuring a difference in time between when the packet was generated and when the packet was transmitted and comparing the difference to a threshold). In this example, timing aligning component 116 can, in one example, select a previously used expected delay parameter that resulted in the lowest time difference between packet generation and transmittal.

In another example, timing aligning component 116 can determine the expected delay based in part on measuring timing of certain processes in previous packet generation procedures. For example, timing aligning component 116 can determine a timing between receiving an analog signal (e.g., or otherwise a timing of the end of the sampling interval) and the time the corresponding packet is generated and/or provided to a MAC layer for transmitting. Timing aligning component 116 can determine the expected delay based at least in part on this timing. In an example, timing aligning component 116 can set the expected delay based on an average of such timings over a period of time, a maximum timing, etc.

In addition, timing aligning component 116 can instead compute timing for aligning its sampling interval based additionally on adding the sampling interval timing to the computed time. Moreover, it is to be appreciated that timing aligning component 116 can add a fixed value to the timing as well in an attempt to generate the packet at a threshold time before the scheduled grant to mitigate impact of unforeseen delay or imprecise expected delay parameter computations. Thus, in one example, timing aligning component 116 can add 1 ms to the computed time in aligning the vocoder component 108. It is to be appreciated that this value can be similarly determined based on previous vocoder timing alignment.

Furthermore, in an example, vocoder component 108 can determine whether to perform timing alignment based on one or more timers or other events. For example, vocoder component 108 can cause timing aligning component 116 to align timing of vocoder component 108 to scheduling interval timing every n seconds or other timing period, based on receiving an indication from a core network, based on detecting initiation of a VoIP or other data call at UE 102, based on detecting a handover of UE 102 to/from another eNB (e.g., during a call or otherwise), and/or the like. In addition, timing aligning component 116 can perform any timing aligning procedures during a silence interval where UE 102 is not communicating voice data to eNB 104 to reduce impact on call quality at UE 102.

In another example, the vocoder component 108 can additionally or alternatively align timing based on measuring end-to-end delay by determining whether a current timing alignment has at most a threshold delay between packet generation and receiving packets for decoding from the eNB 104. If the delay is over the threshold, the vocoder component 108 can shift timing of packet generation, sampling, etc. based on the delay in an attempt to provide an improved alignment of generated packets to SR opportunities or SPS grants. Timing alignment can continue throughout a voice call based on periodically determining the end-to-end delay, for example.

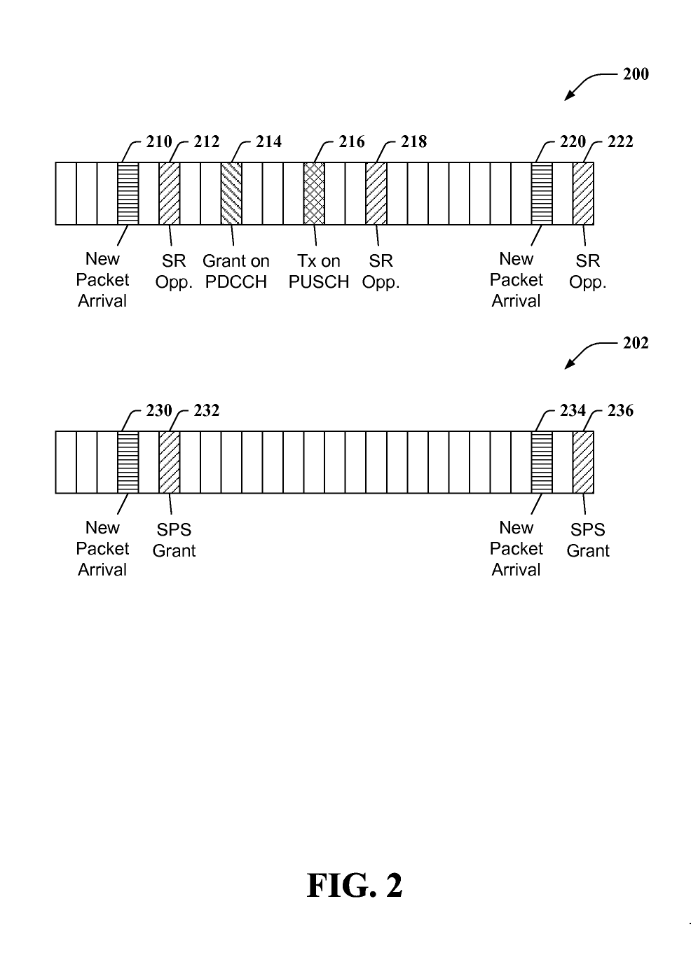

FIG. 2 illustrates an example dynamic scheduling timeline 200 and an example SPS timeline 202. For example, the timelines 200 and/or 202 can be utilized in communications between an eNB and UE, as described herein, and vocoder timing can be aligned based on the timelines 200 and/or 202. Timelines 200 and 202 can represent subframes or other units of time over which eNB can schedule resources for communicating. In LTE, for example, each block of timelines 200 and 202 can be a subframes spanning 1 ms. Block 210 can correspond to new packet arrival at a UE scheduler (e.g., from a vocoder or other application), and block 212 can correspond to a SR opportunity. As the UE scheduler has data for transmitting, it can transmit the SR during the SR opportunity 212. Accordingly, an uplink grant can be received from the eNB at block 214, indicating resources related to block 216, and the UE can transmit the packet at block 216. Subsequently, another SR opportunity occurs at 218, but the UE scheduler does not have data, so it can refrain from transmitting an SR. The UE scheduler can receive data at block 220, however, and accordingly transmit an SR during the SR opportunity at block 222.

In this example, the UE scheduler is aware of SR opportunities at blocks 212, 218, and 222. Thus, the UE can align its vocoder to generate voice data packets before these blocks so the scheduler obtains the data packets and accordingly requests an SR, as described. For example, the vocoder can determine a timing of blocks 212, 218, 222, and/or subsequent SR opportunities (the scheduling interval timing), and add expected delay for generating data packets to the timing to determine the timing for vocoder to begin packet generation. Similarly, for example, the vocoder can add a sampling period to the determined timing to align its sampling interval of received voice signals for generating the related data packets. In any case, aligning the vocoder based on the SRs in this example can minimize delay between generating a data packet at the UE and its subsequent transmittal to the eNB.

Timeline 202 depicts an example SPS scheduling timeline where regular SPS grants are received in a periodic interval from an eNB, at blocks 232 and 236. Where the UE has packets to transmit at 230 and 234, resources of the SPS grant at 232 and 236 can be used to transmit the packets. In one example, the UE determines the scheduling timing interval of the SPS grants from a hardcoding or configuration, and/or determines the actual timing based on receiving an initial SPS grant from the eNB or other indication. In either case, the UE scheduler can be aware of the actual scheduling interval timing for the SPS grants, and can accordingly align the vocoder to generate packets prior to receiving each SPS grant, as described, to minimize delay between completion of packet generation and the SPS grant.

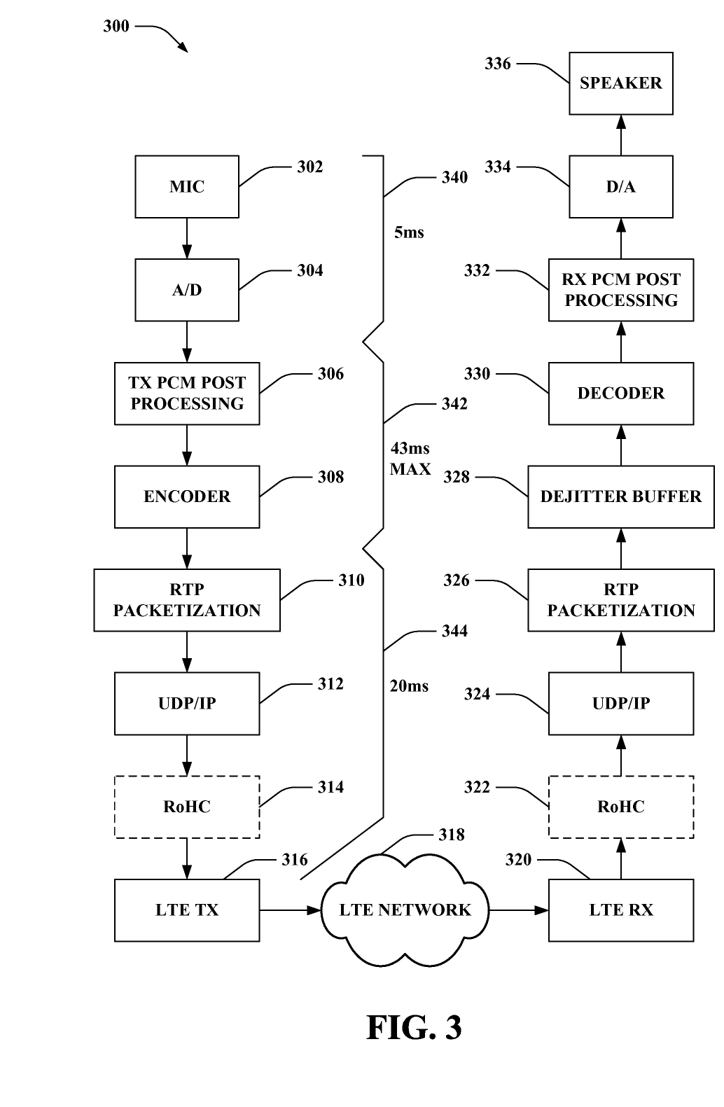

FIG. 3 illustrates an example VoIP coding and communicating process 300 for a transmitter and receiver. For example, microphone 302 can receive analog voice signals over a sampling interval, and convert the analog signals to digital signals 304. Transmit pulse code modulation (PCM) post processing 306 can be performed for the digital signals, and the signals can be encoded by encoder 308, which can be a vocoder for example. Real-time transport protocol (RTP) packetization 310 is performed to formulate the encoded signal into packets for transmitting in a wireless network. The packets can be provided to a user datagram protocol (UDP)/internet protocol (IP) layer 312. Robust header compression (RoHC) 314 is optionally performed on the packets, and the packets can be transmitted over an LTE network 318 using an LTE transmitter 316 (e.g., via an eNB and other LTE network components).

The packets are received at LTE receiver 320, which can be at another UE. RoHC decompression 322 is performed on the packets, and the packets are provided to UDP/IP layer 324. RTP packetization 326 can process the packets to generate the corresponding digital signal. The signal is provided to dejitter buffer 328 to queue the signal for providing to upper layers sequentially with other signals. Decoder 330 decodes the VoIP signal, and receive PCM post processing 322 is performed to demodulate the signal. The signal is converted from digital to an analog signal 334 and provided to a speaker at 336.

In this example, associated delays are shown for certain steps of the encoding process, such as 5 ms delay for the processes at 340, including receiving the analog signal from the microphone 302 and converting to digital at 304, a 43 ms maximum delay for processes at 342, including transmit PCM post processing 306 and encoding 308, as well as 20 ms delay in processes at 344. In this regard, an expected delay of the processes can be computed and used to align a vocoder component, as described. For example, given a desired time for completing encoding (e.g., a scheduling interval timing), the vocoder component can add delay associated with at least processes at 340 and 342 (e.g., 48 ms) to the desired time. In this example, after the expected delay, the vocoder component can be expected to be in the RTP packetization 310 process in time for providing the packet to lower layers for requesting a SR or scheduling in an SPS grant. Moreover, a sampling interval can be added to the computed time to determine when to begin sampling analog signals at the UE.

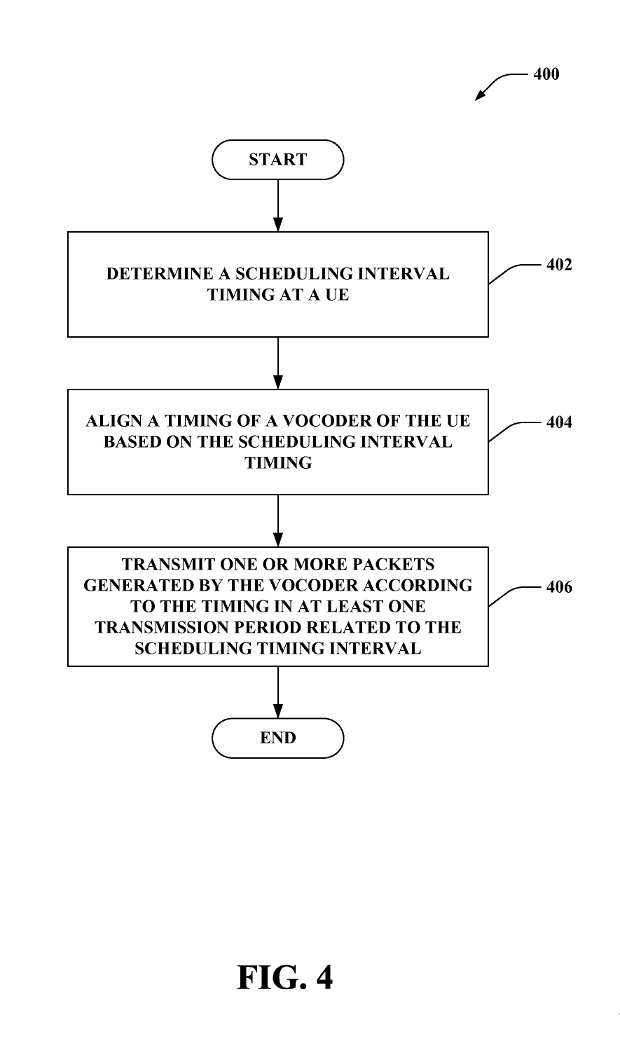

FIG. 4 illustrates an example methodology 400 for aligning timing of a vocoder. While, for purposes of simplicity of explanation, the methodology is shown and described as a series of acts, it is to be understood and appreciated that the methodology is not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

At 402, a scheduling interval timing can be determined at a UE. For example, the scheduling interval timing can be obtained from a UE scheduler and can include a SR configuration (e.g., periodicity, offset, etc.), a SPS scheduling interval, etc. Moreover, the scheduling interval timing can be an absolute or relative timing (e.g., relative to a current timing).

At 404, a timing of a vocoder of the UE can be aligned based on the scheduling interval timing. For example, an expected delay for packet generation at the vocoder can be added to the determined scheduling interval timing to align the timing of the vocoder. For instance, the expected delay can be a hardcoded or configured value at the UE and/or can be determined based on measuring timing of one or more previous packet generation processes at the UE. Moreover, for example, another fixed timing value can be added to account for potential imprecision in determining the expected delay. The sampling interval can be added as well to determine when to begin sampling to result in completion of packet generation according to the scheduling interval timing.

At 406, one or more packets generated by the vocoder can be transmitted according to the timing in at least one transmission period related to the scheduling timing interval. For example, aligning the timing of the vocoder can result in the one or more packets generated near the same time as the scheduling timing interval, and thus, the one or more packets are transmitted in a time period corresponding to the scheduling timing interval. Where the UE uses dynamic scheduling and the scheduling timing interval corresponds to an SR, the one or more packets are generated before the transmission period for the SR such that providing the one or more packets to the lower layer results in transmitting the SR during the SR opportunity for the one or more packets. Where the UE uses SPS and the scheduling timing interval corresponds to an SPS grant, the one or more packets are generated before the transmission period corresponding to the SPS grant to transmitting the one or more packets.

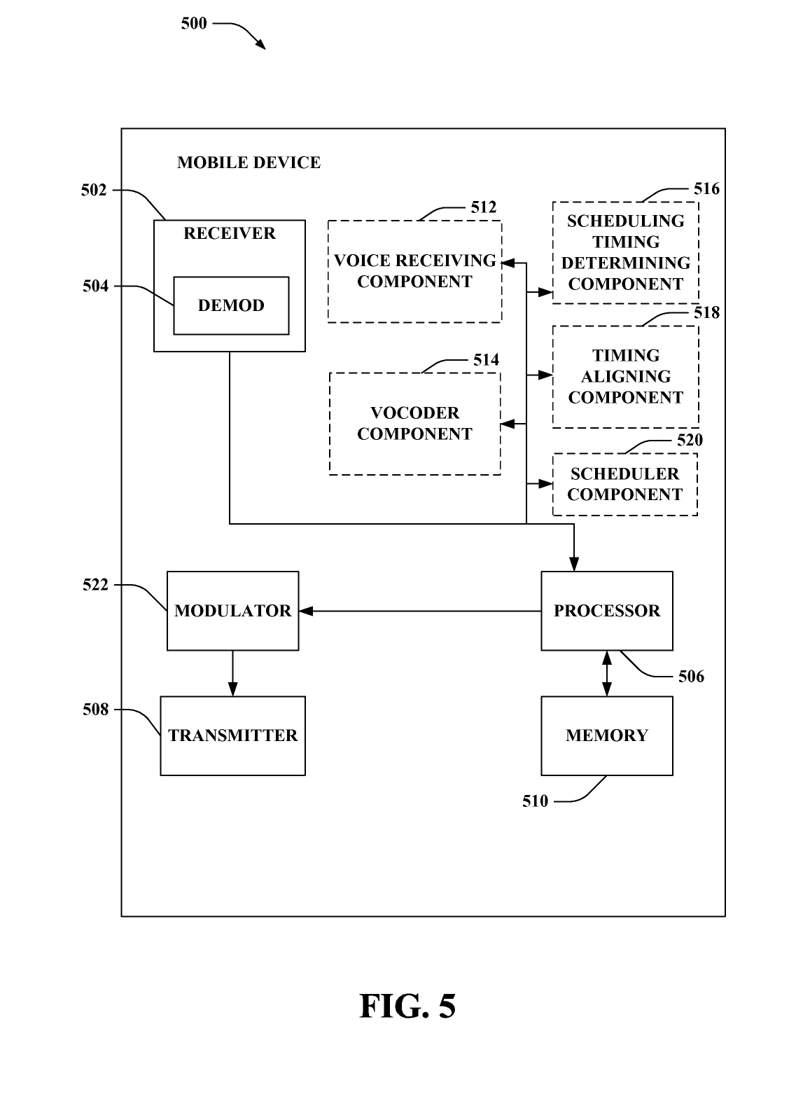

FIG. 5 is an illustration of a mobile device 500 that facilitates aligning timing of a vocoder. Mobile device 500 may include a receiver 502 that receives a signal from, for instance, a receive antenna (not shown), performs typical actions on (e.g., filters, amplifies, downconverts, etc.) the received signal, and digitizes the conditioned signal to obtain samples. Receiver 502 can include a demodulator 504 that can demodulate received symbols and provide them to a processor 506 for channel estimation. Processor 506 can be a processor dedicated to analyzing information received by receiver 502 and/or generating information for transmission by a transmitter 508, a processor that controls one or more components of mobile device 500, and/or a processor that both analyzes information received by receiver 502, generates information for transmission by transmitter 508, and controls one or more components of mobile device 500.

Mobile device 500 can additionally include memory 510 that is operatively coupled to processor 506 and that can store data to be transmitted, received data, information related to available channels, data associated with analyzed signal and/or interference strength, information related to an assigned channel, power, rate, or the like, and any other suitable information for estimating a channel and communicating via the channel. Memory 510 can additionally store protocols and/or algorithms associated with estimating and/or utilizing a channel (e.g., performance based, capacity based, etc.).

It will be appreciated that the data store (e.g., memory 510) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 510 of the subject systems and methods is intended to include, without being limited to, these and any other suitable types of memory.

Processor 506 can further be optionally operatively coupled to a voice receiving component 512, which can be similar to voice receiving component 106, a vocoder component 514, which can be similar to vocoder component 108, a scheduling timing determining component 516, which can be similar to scheduling timing determining component 114, a timing aligning component 518, which can be similar to timing aligning component 116, and/or a scheduler component 520, which can be similar to scheduler component 110. Mobile device 500 still further includes a modulator 522 that modulates signals for transmission by transmitter 508 to, for instance, a base station, another mobile device, etc. For example, transmitter 508 can transmit serving cell identifiers to a positioning server via one or more base stations, as described, and can be similar to transmitting component 112. Moreover, for example, mobile device 500 can include multiple transmitters 508 for multiple network interfaces, as described. Although depicted as being separate from the processor 506, it is to be appreciated that the voice receiving component 512, vocoder component 514, scheduling timing determining component 516, timing aligning component 518, scheduler component 520, demodulator 504, and/or modulator 522 can be part of the processor 506 or multiple processors (not shown)), and/or stored as instructions in memory 510 for execution by processor 506.

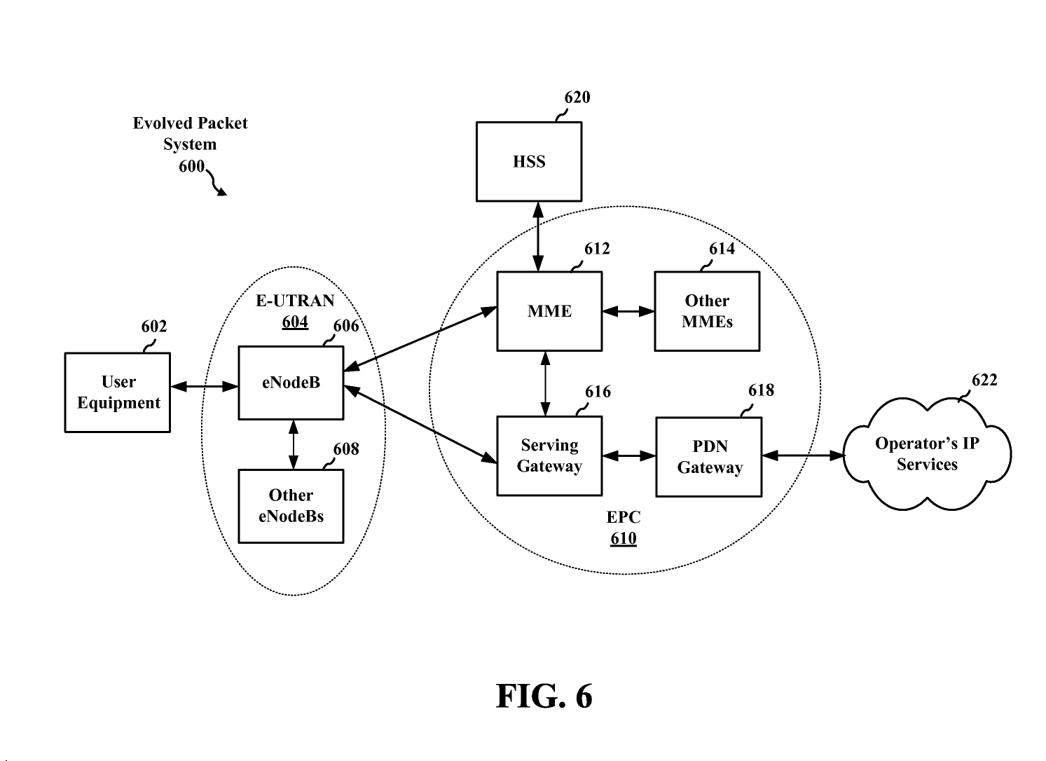

FIG. 6 is a diagram illustrating an LTE network architecture 600. The LTE network architecture 600 may be referred to as an Evolved Packet System (EPS) 600. The EPS 600 may include one or more user equipment (UE) 602, an Evolved UMTS Terrestrial Radio Access Network (E-UTRAN) 604, an Evolved Packet Core (EPC) 610, a Home Subscriber Server (HSS) 620, and an Operator's IP Services 622. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 606 and other eNBs 608. The eNB 606 provides user and control planes protocol terminations toward the UE 602. The eNB 606 may be connected to the other eNBs 608 via an X2 interface (e.g., backhaul). The eNB 606 may also be referred to as a base station, a base transceiver station, a radio base station, a radio transceiver, a transceiver function, a basic service set (BSS), an extended service set (ESS), or some other suitable terminology. The eNB 606 provides an access point to the EPC 610 for a UE 602. Examples of UEs 602 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 602 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 606 is connected by an S1 interface to the EPC 610. The EPC 610 includes a Mobility Management Entity (MME) 612, other MMEs 614, a Serving Gateway 616, and a Packet Data Network (PDN) Gateway 618. The MME 612 is the control node that processes the signaling between the UE 602 and the EPC 610. Generally, the MME 612 provides bearer and connection management. All user IP packets are transferred through the Serving Gateway 616, which itself is connected to the PDN Gateway 618. The PDN Gateway 618 provides UE IP address allocation as well as other functions. The PDN Gateway 618 is connected to the Operator's IP Services 622. The Operator's IP Services 622 may include the Internet, the Intranet, an IP Multimedia Subsystem (IMS), and a PS Streaming Service (PSS).

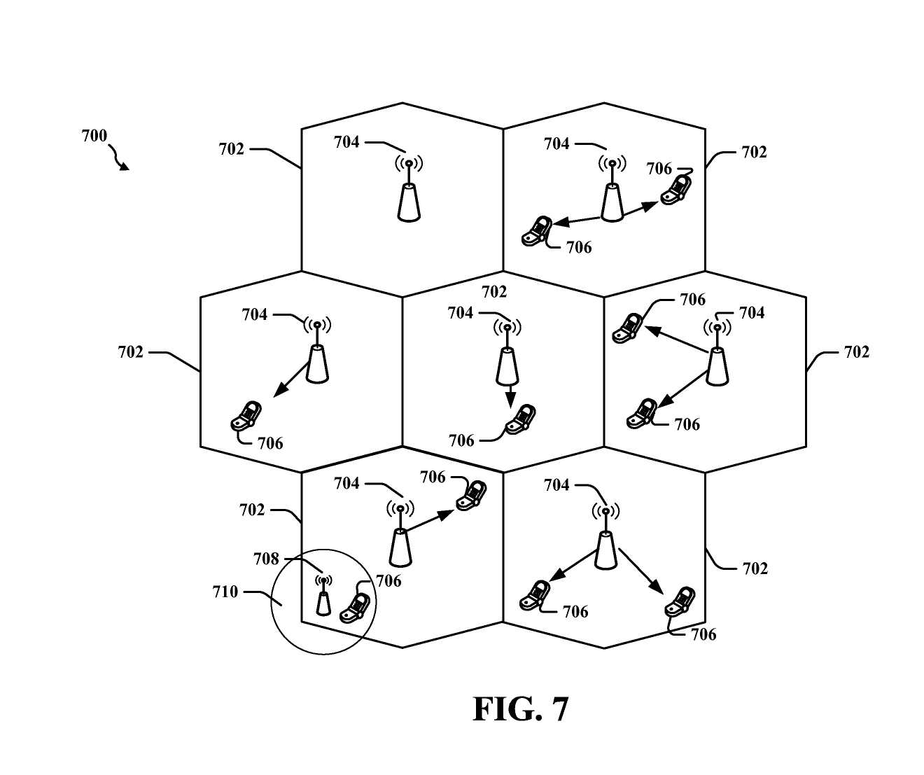

FIG. 7 is a diagram illustrating an example of an access network 700 in an LTE network architecture. In this example, the access network 700 is divided into a number of cellular regions (cells) 702. One or more lower power class eNBs 708 may have cellular regions 710 that overlap with one or more of the cells 702. A lower power class eNB 708 may be referred to as a remote radio head (RRH). The lower power class eNB 708 may be a femto cell (e.g., home eNB (HeNB)), pico cell, or micro cell). The macro eNBs 704 are each assigned to a respective cell 702 and are configured to provide an access point to the EPC 610 for all the UEs 706 in the cells 702. There is no centralized controller in this example of an access network 700, but a centralized controller may be used in alternative configurations. The eNBs 704 are responsible for all radio related functions including radio bearer control, admission control, mobility control, scheduling, security, and connectivity to the serving gateway 616.

The modulation and multiple access scheme employed by the access network 700 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 704 may have multiple antennas supporting MIMO technology. The use of MIMO technology enables the eNBs 704 to exploit the spatial domain to support spatial multiplexing, beamforming, and transmit diversity. Spatial multiplexing may be used to transmit different streams of data simultaneously on the same frequency. The data steams may be transmitted to a single UE 706 to increase the data rate or to multiple UEs 706 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 706 with different spatial signatures, which enables each of the UE(s) 706 to recover the one or more data streams destined for that UE 706. On the UL, each UE 706 transmits a spatially precoded data stream, which enables the eNB 704 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

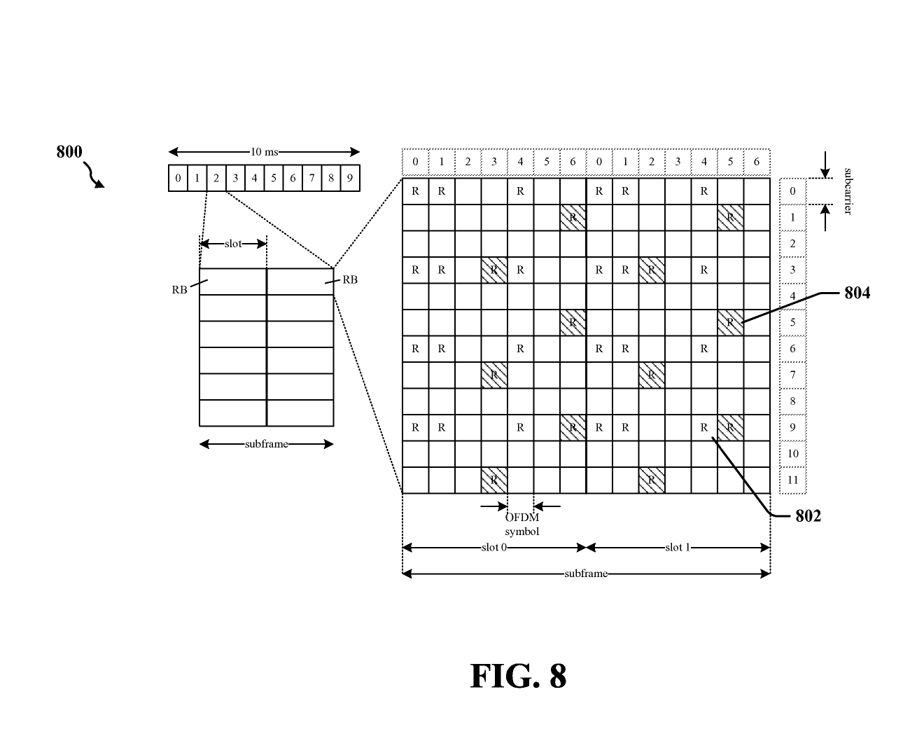

FIG. 8 is a diagram 800 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 802, 804, include DL reference signals (DL-RS). The DL-RS include Cell-specific RS (CRS) (also sometimes called common RS) 802 and UE-specific RS (UE-RS) (also known as demodulation reference signals (DM-RS)) 804. UE-RS 804 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

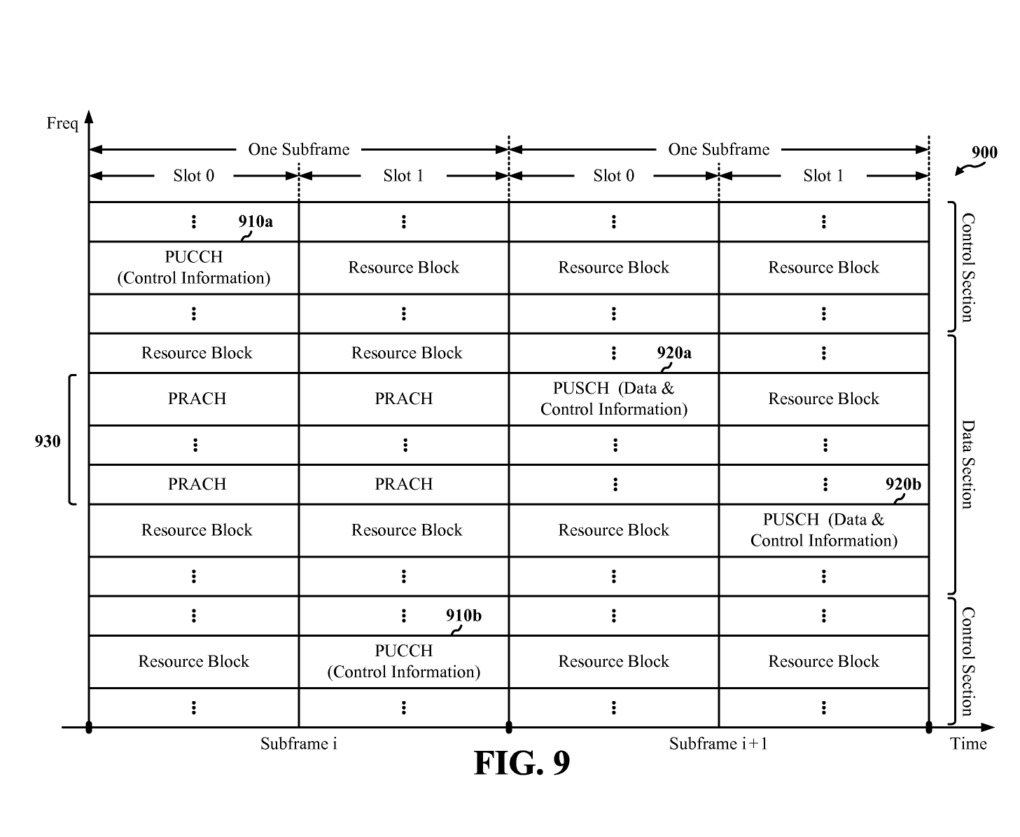

FIG. 9 is a diagram 900 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 910a, 910b in the control section to transmit control information to an eNB. The UE may also be assigned resource blocks 920a, 920b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 930. The PRACH 930 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

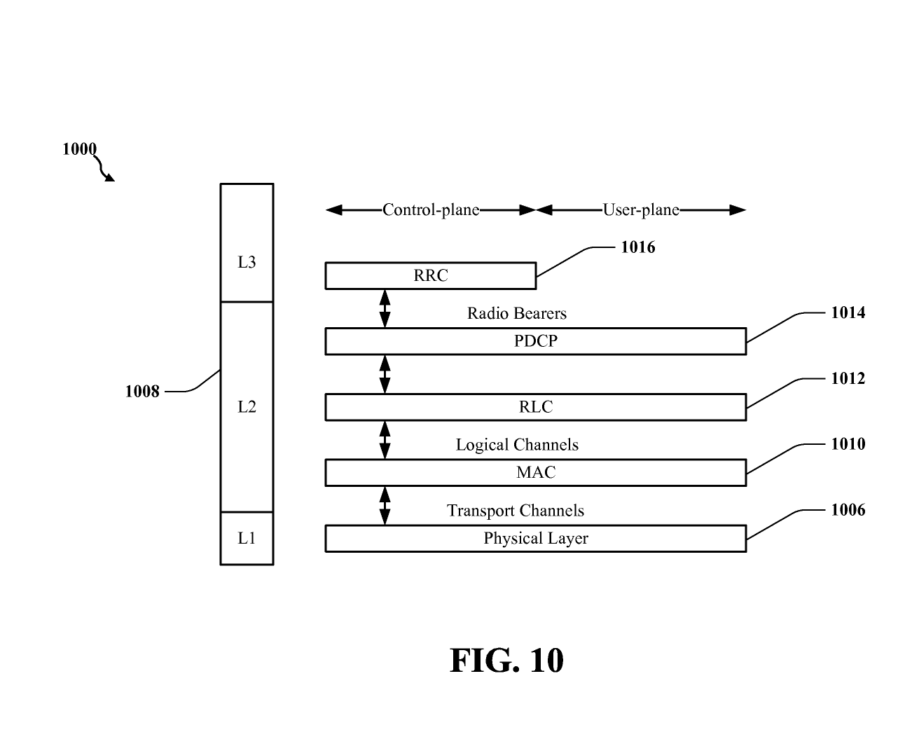

FIG. 10 is a diagram 1000 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 1006. Layer 2 (L2 layer) 1008 is above the physical layer 1006 and is responsible for the link between the UE and eNB over the physical layer 1006.

In the user plane, the L2 layer 1008 includes a media access control (MAC) sublayer 1010, a radio link control (RLC) sublayer 1012, and a packet data convergence protocol (PDCP) 1014 sublayer, which are terminated at the eNB on the network side. Although not shown, the UE may have several upper layers above the L2 layer 1008 including a network layer (e.g., IP layer) that is terminated at the PDN gateway 1018 on the network side, and an application layer that is terminated at the other end of the connection (e.g., far end UE, server, etc.).

The PDCP sublayer 1014 provides multiplexing between different radio bearers and logical channels. The PDCP sublayer 1014 also provides header compression for upper layer data packets to reduce radio transmission overhead, security by ciphering the data packets, and handover support for UEs between eNBs. The RLC sublayer 1012 provides segmentation and reassembly of upper layer data packets, retransmission of lost data packets, and reordering of data packets to compensate for out-of-order reception due to hybrid automatic repeat request (HARQ). The MAC sublayer 1010 provides multiplexing between logical and transport channels. The MAC sublayer 1010 is also responsible for allocating the various radio resources (e.g., resource blocks) in one cell among the UEs. The MAC sublayer 1010 is also responsible for HARQ operations.

In the control plane, the radio protocol architecture for the UE and eNB is substantially the same for the physical layer 1006 and the L2 layer 1008 with the exception that there is no header compression function for the control plane. The control plane also includes a radio resource control (RRC) sublayer 1016 in Layer 3 (L3 layer). The RRC sublayer 1016 is responsible for obtaining radio resources (e.g., radio bearers) and for configuring the lower layers using RRC signaling between the eNB and the UE.

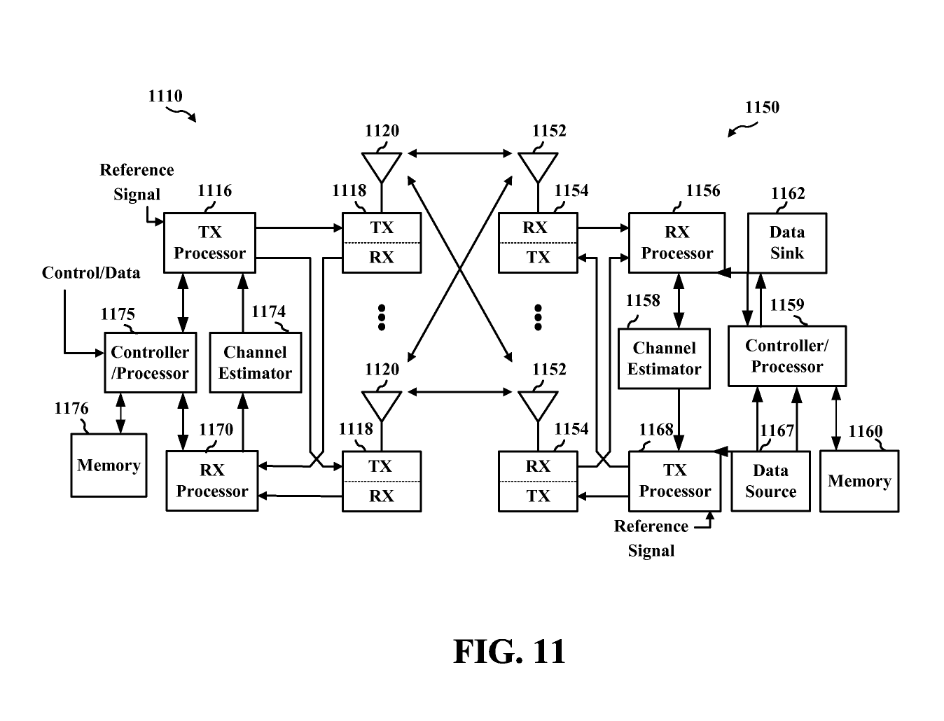

FIG. 11 is a block diagram of an eNB 1110 in communication with a UE 1150 in an access network. In the DL, upper layer packets from the core network are provided to a controller/processor 1175. The controller/processor 1175 implements the functionality of the L2 layer. In the DL, the controller/processor 1175 provides header compression, ciphering, packet segmentation and reordering, multiplexing between logical and transport channels, and radio resource allocations to the UE 1150 based on various priority metrics. The controller/processor 1175 is also responsible for HARQ operations, retransmission of lost packets, and signaling to the UE 1150.

The transmit (TX) processor 1116 implements various signal processing functions for the L1 layer (e.g., physical layer). The signal processing functions includes coding and interleaving to facilitate forward error correction (FEC) at the UE 1150 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 1174 may be used to determine the coding and modulation scheme, as well as for spatial processing. The channel estimate may be derived from a reference signal and/or channel condition feedback transmitted by the UE 1150. Each spatial stream is then provided to a different antenna 1120 via a separate transmitter 1118TX. Each transmitter 1118TX modulates an RF carrier with a respective spatial stream for transmission.

At the UE 1150, each receiver 1154RX receives a signal through its respective antenna 1152. Each receiver 1154RX recovers information modulated onto an RF carrier and provides the information to the receive (RX) processor 1156. The RX processor 1156 implements various signal processing functions of the L1 layer. The RX processor 1156 performs spatial processing on the information to recover any spatial streams destined for the UE 1150. If multiple spatial streams are destined for the UE 1150, they may be combined by the RX processor 1156 into a single OFDM symbol stream. The RX processor 1156 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 1110. These soft decisions may be based on channel estimates computed by the channel estimator 1158. The soft decisions are then decoded and deinterleaved to recover the data and control signals that were originally transmitted by the eNB 1110 on the physical channel. The data and control signals are then provided to the controller/processor 1159.

The controller/processor 1159 implements the L2 layer. The controller/processor can be associated with a memory 1160 that stores program codes and data. The memory 1160 may be referred to as a computer-readable medium. In the UL, the control/processor 1159 provides demultiplexing between transport and logical channels, packet reassembly, deciphering, header decompression, control signal processing to recover upper layer packets from the core network. The upper layer packets are then provided to a data sink 1162, which represents all the protocol layers above the L2 layer. Various control signals may also be provided to the data sink 1162 for L3 processing. The controller/processor 1159 is also responsible for error detection using an acknowledgement (ACK) and/or negative acknowledgement (NACK) protocol to support HARQ operations.

In the UL, a data source 1167 is used to provide upper layer packets to the controller/processor 1159. The data source 1167 represents all protocol layers above the L2 layer. Similar to the functionality described in connection with the DL transmission by the eNB 1110, the controller/processor 1159 implements the L2 layer for the user plane and the control plane by providing header compression, ciphering, packet segmentation and reordering, and multiplexing between logical and transport channels based on radio resource allocations by the eNB 1110. The controller/processor 1159 is also responsible for HARQ operations, retransmission of lost packets, and signaling to the eNB 1110.

Channel estimates derived by a channel estimator 1158 from a reference signal or feedback transmitted by the eNB 1110 may be used by the TX processor 1168 to select the appropriate coding and modulation schemes, and to facilitate spatial processing. The spatial streams generated by the TX processor 1168 are provided to different antenna 1152 via separate transmitters 1154TX. Each transmitter 1154TX modulates an RF carrier with a respective spatial stream for transmission.

The UL transmission is processed at the eNB 1110 in a manner similar to that described in connection with the receiver function at the UE 1150. Each receiver 1118RX receives a signal through its respective antenna 1120. Each receiver 1118RX recovers information modulated onto an RF carrier and provides the information to a RX processor 1170. The RX processor 1170 may implement the L1 layer.

The controller/processor 1175 implements the L2 layer. The controller/processor 1175 can be associated with a memory 1176 that stores program codes and data. The memory 1176 may be referred to as a computer-readable medium. In the UL, the control/processor 1175 provides demultiplexing between transport and logical channels, packet reassembly, deciphering, header decompression, control signal processing to recover upper layer packets from the UE 1150. Upper layer packets from the controller/processor 1175 may be provided to the core network. The controller/processor 1175 is also responsible for error detection using an ACK and/or NACK protocol to support HARQ operations.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for aligning a voice-over-internet protocol (VoIP) vocoder timing at a user equipment (UE), comprising;
determining a scheduling interval timing at a UE;
aligning a timing of a vocoder of the UE based on the scheduling interval timing; and
transmitting one or more packets generated by the vocoder according to the timing in at least one transmission period related to the scheduling interval timing.

2. The method of claim 1, wherein the aligning the timing comprises determining a packet generation timing for the vocoder to generate the one or more packets before the at least one transmission period.

3. The method of claim 2, wherein the determining the packet generation timing is based in part on an expected delay associated with packet generation at the vocoder.

4. The method of claim 2, wherein the aligning the timing further comprises adjusting the packet generation timing according to a sampling interval at the vocoder.

5. The method of claim 1, wherein the scheduling interval timing corresponds to a timing received by an evolved Node B (eNB) for transmitting scheduling requests to the eNB.

6. The method of claim 1, wherein the scheduling interval timing corresponds to a timing for receiving semi-persistent scheduling grants from an evolved Node B.

7. The method of claim 1, wherein the scheduling interval timing corresponds to a discontinuous receive active time.

8. The method of claim 1, wherein the determining the scheduling interval timing comprises receiving the scheduling interval timing from a scheduler at the UE.

9. An apparatus for aligning a voice-over-internet protocol (VoIP) vocoder timing at a user equipment (UE), comprising:
means for determining a scheduling interval timing at a UE;
means for aligning a timing of a vocoder of the UE based on the scheduling interval timing; and
means for transmitting one or more packets generated by the vocoder according to the timing in at least one transmission period related to the scheduling interval timing.

10. The apparatus of claim 9, wherein the means for aligning aligns the timing based in part on determining a packet generation timing for the vocoder to generate the one or more packets before the at least one transmission period.

11. The apparatus of claim 10, wherein the means for aligning determines the packet generation timing based in part on an expected delay associated with packet generation at the vocoder.

12. The apparatus of claim 9, wherein the scheduling interval timing corresponds to at least one of a timing received by an evolved Node B (eNB) for transmitting scheduling requests to the eNB, a timing for receiving semi-persistent scheduling grants from the eNB, or a discontinuous receive active time from the eNB.

13. A computer program product for aligning a voice-over-internet protocol (VoIP) vocoder timing at a user equipment (UE), comprising:
a non-transitory computer-readable medium comprising:
code for causing at least one computer to determine a scheduling interval timing at a UE;
code for causing the at least one computer to align a timing of a vocoder of the UE based on the scheduling interval timing; and
code for causing the at least one computer to transmit one or more packets generated by the vocoder according to the timing in at least one transmission period related to the scheduling interval timing.

14. The computer program product of claim 13, wherein the code for causing the at least one computer to align aligns the timing based in part on determining a packet generation timing for the vocoder to generate the one or more packets before the at least one transmission period.

15. The computer program product of claim 14, wherein the code for causing the at least one computer to align determines the packet generation timing based in part on an expected delay associated with packet generation at the vocoder.

16. The computer program product of claim 13, wherein the scheduling interval timing corresponds to at least one of a timing received by an evolved Node B (eNB) for transmitting scheduling requests to the eNB, a timing for receiving semi-persistent scheduling grants from the eNB, or a discontinuous receive active time from the eNB.

17. An apparatus for aligning a voice-over-internet protocol (VoIP) vocoder timing at a user equipment (UE), comprising:
a processor;
a memory in electronic communication with the processor;
instructions stored in the memory, the instructions being executable by the processor to:
determine a scheduling interval timing at a UE;
align a timing of a vocoder of the UE based on the scheduling interval timing; and
transmit one or more packets generated by the vocoder according to the timing in at least one transmission period related to the scheduling interval timing.

18. The apparatus of claim 17, wherein the instructions being executable by the processor to align the timing align the timing based in part on determining a packet generation timing for the vocoder to generate the one or more packets before the at least one transmission period.

19. The apparatus of claim 18, wherein the instructions being executable by the processor to align the timing comprise instructions for determining the packet generation timing based in part on an expected delay associated with packet generation at the vocoder.

20. The apparatus of claim 17, wherein the scheduling interval timing corresponds to at least one of a timing received by an evolved Node B (eNB) for transmitting scheduling requests to the eNB, a timing for receiving semi-persistent scheduling grants from the eNB, or a discontinuous receive active time from the eNB.

21. An apparatus for aligning a voice-over-internet protocol (VoIP) vocoder timing at a user equipment (UE), comprising:
a scheduling timing determining component for determining a scheduling interval timing at a UE;
a timing aligning component for aligning a timing of a vocoder of the UE based on the scheduling interval timing; and
a transmitting component for transmitting one or more packets generated by the vocoder according to the timing in at least one transmission period related to the scheduling interval timing.

22. The apparatus of claim 21, wherein the timing aligning component aligns the timing based in part on determining a packet generation timing for the vocoder to generate the one or more packets before the at least one transmission period.

23. The apparatus of claim 22, wherein the timing aligning component determines the packet generation timing based in part on an expected delay associated with packet generation at the vocoder.

24. The method of claim 22, wherein the timing aligning component further adjusts the packet generation timing according to a sampling interval at the vocoder.

25. The apparatus of claim 21, wherein the scheduling interval timing corresponds to a timing received by an evolved Node B (eNB) for transmitting scheduling requests to the eNB.

26. The apparatus of claim 21, wherein the scheduling interval timing corresponds to a timing for receiving semi-persistent scheduling grants from the eNB.

27. The apparatus of claim 21, wherein the scheduling interval timing corresponds to a discontinuous receive active time.

28. The apparatus of claim 21, wherein the scheduling timing determining component receives the scheduling interval timing from a scheduler at the UE.
